(19) United States
(12) Patent Application Publication
(10) Pub. No.: US 2011/0160403 A1
(43) Pub. Date: Jun. 30, 2011

(54) Films of polyethlene blends

(75) Inventor: Harilaos Mavridis, Lebanon, OH (US)

(73) Assignee: Equistar Chemicals, LP, Houston, TX (US)

(21) Appl. No.: 12/655,427

(22) Filed: Dec. 30, 2009

(51) Int. Cl. C08L 23/06; B29C 47/00

(52) U.S. Cl. 525/240; 264/176.1

(57) ABSTRACT

A film comprising a polymer blend of
0.3 to 0.8 wt % LDPE; and
99.2 to 99.7 wt % LLDPE,
the LDPE having an MI of 0.1 to 0.6 dg/min, and the blend having a slice long chain branching of at least 0.96 for any portion of the composition having a molecular weight of 100,000 or above, wherein the film is formed from an extrudate of the blend.

### FIELD OF THE INVENTION

The invention relates to films having a good balance of optical and physical properties made from blends of fractional melt index low density polyethylene and linear low density polyethylene, to a process for producing the film, and the blend composition.

### BACKGROUND OF THE INVENTION

Polyethylene films are used in a wide range of products and applications that generally fall into the categories of packaging and non-packaging. Packaging applications include food packaging, such as in-store produce bags and other containers for food; non-food packaging applications such as those for supported structures such as gaylord boxes, or those for containing various materials such as mulch bags, and other applications using stretch and shrink wrap films. Non-packaging applications include trash bags, can liners, construction film, such as vapor barriers in walls, and consumer products such as diapers.

Physical properties important in polyethylene films include tear strength, impact strength, tensile strength, stiffness and transparency. Overall film strength is desirable so that the films may be employed in applications without risk of physical failure. Transparency is an important property since it is desirable to have the flexibility to inspect items within a container without actually opening it.

Polyethylene films have been produced using different types of polymers to meet the demands of particular applications. Low density polyethylene (LDPE) and linear low density polyethylene (LLDPE) can be heat-sealed and have good barrier characteristics. In addition, LDPE particularly excels in applications demanding high clarity, ease of processing and high gloss. LLDPE is especially useful for applications requiring tensile and impact strength properties. However, blends of the two polyethylenes typically result in films with good optical properties but poor physical properties, particularly for thin films.

Various attempts have been made to combine the favorable optical properties of LDPE and good structural properties of LLDPEs. U.S. Pat. Publ. No. 2006/0047077 discloses plastic films prepared by coextruding a blend of 1.5 to 4.5 wt % of a high pressure low density polyethylene having a melt index of 0.1 to 0.8 dg/min, and 95.5 to 98.5 of a linear low density polyethylene. U.S. Pat. No. 6,130,293 discloses a composition containing 1 to 3 wt % of an ethylene homopolymer having a melt index of about 1 to about 4 dg/min and 97 to 99 wt % of a linear ethylene-alpha olefin copolymer. U.S. Pat. No. 5,455,303 discloses films made from a blend of a reactor-made material containing a linear low density polyethylene and a C₃-based material, with a low density polyethylene having a melt index of 0.2 to 20 dg/min. U.S. Pat. No. 6,870,010 discloses a low density substantially linear polyethylene composition having a slice long chain branching index of 0.85 or less for any portion of the composition having a molecular weight of the 100,000 or above. However, in conventional blends of LDPE and LLDPE, the level of LDPE required to provide a desired improvement in optical properties often results in an unacceptable decrease in physical properties. Therefore, a continuing need exists for ethylene polymer blends for films having a superior balance of optical and physical properties, obtained with low levels of the LDPE component.

### SUMMARY OF THE INVENTION

The invention relates to a film comprising a blend of 0.3 to 0.8 wt % LDPE and 99.2 to 99.7 wt % LLDPE, the LDPE having an MI of 0.1 to 0.6 dg/min, and the LLDPE having a slice long chain branching index of at least 0.96 for any portion of the composition having a molecular weight of 100,000 or above, wherein the film is formed from an extrudate of the blend. The invention also relates to a process for producing the film and the blend composition.

### DETAILED DESCRIPTION OF THE INVENTION

It has unexpectedly been found that films formed from an extrudate blend containing very low levels of a fractional melt index low density polyethylene and a linear low density polyethylene having a long chain branching index of at least 0.96 provides an improved balance of optical and impact properties. The films of the invention exhibit excellent optical properties while retaining good mechanical properties.

The LDPE is preferably produced by either a tubular or autoclave high-pressure polymerization process and has a melt index (MI) as measured by ASTM D 1238, condition 190/2.16, of 0.1 to 0.6 dg/min, preferably from 0.1 to 0.4 dg/min, and a density of 0.910 to 0.940 g/cm³.

The LLDPE has a density of 0.915 to 0.940 g/cm³, and an MI from 0.2 to 10 dg/min, preferably from 0.5 to 5.0, and is a copolymer of ethylene and a C₄ to C₈ alpha olefin, where the alpha olefin is present in an amount sufficient to reduce the polyethylene density to the desired level, typically in an amount from about 2 wt % to about 12 wt %. The LLDPE is produced in a single-stage or multi-stage process. Preferably, the LLDPE is produced using a Ziegler-Natta catalyst. Preferably, the catalyst used is as described in WO 2005/058982. The comonomer of the LLDPE is preferably selected from 1-butene, 1-pentene, 1-hexene, 4-methyl-1-pentene, 1-heptene or 1-octene. More preferably, the comonomer is selected from 1-butene, 1-hexene or 1-octene. Most preferably, the comonomer is 1-butene or 1-hexene.

The LLDPEs used in the films of the invention have little or no long chain branching. This is evidenced by a value of the slice long chain branching index (SLCB), determined according to the procedure outlined in U.S. Pat. No. 6,870,010, of at least 0.96 for any portion of the composition having a molecular weight of 100,000 or more. These LLDPE's exhibit improved haze reductions when blended with the LDPE used in films of the invention.

The blended composition contains from 0.3 to 0.8 wt % LDPE and 99.2 to 99.7 wt % LLDPE, preferably 0.3 to 0.6 wt % LDPE and 99.4 to 99.7 wt % LLDPE based on the total amount of LDPE and LLDPE. The compositions used in the films preferably have an SLCB of at least 0.96.

The film blends are preferably prepared by melt-blending the LDPE with the LLDPE before film extrusion to form a blend extrudate and then feeding the extrudate to the film extruder. For example, the LDPE can be melt-extruded into the LLDPE along with other additives during the finishing and pelletization step in the LLDPE production or post-LLDPE production, such as in a Banbury mixer, twin screw extruder or similar equipment known to those skilled in the art. Blending the components in such a way provides improved performance over dry-blending the components together during film extrusion, e.g., in the feed to the film extruder processing the blend.

The films of the invention exhibit an enhanced balance of properties. Haze is determined in accordance with ASTM D1003. Preferably, films prepared from the compositions of the invention have a haze, as measured in a 1-mil film, of less than 15%. Gloss-45 is determined in accordance with ASTM D2457. Preferably, films prepared from the compositions of the invention have a gloss-45, as measured in a 1-mil film, of greater than 50%. Clarity is determined in accordance with ASTM D1746. Preferably, antiblock-free films prepared from compositions of the invention have a clarity as measured in a 1-mil film of greater than 70%, more preferably greater than 75%. Dart drop impact (DDI) is determined in accordance with ASTM D1709. Preferably, films prepared from compositions of the invention have a DDI, as measured in a 1-mil film, of greater than 80 g/mil, more preferably greater than 90 g/mil, most preferably greater than 95. Elmendorf Tear (MD-Tear) is determined in accordance with ASTM D1922. Preferably, films prepared from compositions of the invention have an MD-Tear as measured in a 1-mil film of greater than 80 g/mil, more preferably greater than 90 g/mil.

Preferably the films of the invention have a haze less than 12% while also having a DDI of greater than 90 g/mil.

Films produced from the compositions exhibit an improved blend of optical and physical properties when compared with conventional blends of LLDPE and LDPE, i.e., the blends demonstrate a reduced negative impact on physical properties for a given improvement in haze. Alternately, for a given amount of LDPE, films produced from the compositions demonstrate an improved reduction in haze. At the very low levels of LDPE in the compositions (less than 1 wt %), standard conventional feeders typical of additive systems, can be used for the addition of the LDPE to the LLDPE, thereby saving capital investment. Very low percentages of LDPE in the film blend also provide cost advantages over systems containing higher levels of LDPE, since LDPE is typically more expensive than LLDPE.

The blended composition can be used with or without additives. When present, the additives are preferably selected from stabilizers, anti-block agents, UV absorbers, metal deactivators, thiosynergists, peroxide scavengers, basic co-stabilizers, acid scavengers, nucleating agents, clarifiers, conventional fillers, dispersing agents, plasticizers, lubricants, emulsifiers, pigments, flow-control agents, optical brighteners, flame-proofing agents, antistatic agents, blowing agents, and mixtures thereof.

In this specification, the term “film” shall mean a single layer or multiple layers of the polymer blend, each layer having a thickness of from 0.1 to 10 mils. The films can be of any type prepared by processes well known to those skilled in the art, such as cast, blown-air, blown-water, oriented, and biaxially oriented. The films may also be used in extrusion coating and extrusion lamination processes. When the films are coextruded, they can be produced using conventional methods and extrusion equipment well known to those skilled in the art, where layers of polymer melts are combined by introducing multiple polymer melt streams into a combining block/manifold or die which then directs the melt streams to flow together (while still in the block/manifold or die), then exiting the die together as a single flow stream. Alternately, multiple polymer melt streams can be introduced into a die and then combined just after exiting the die.

Preferably, the films are blown or cast films. More preferably, the films are blown films.

The following examples illustrate the invention; however, those skilled in the art will recognize numerous variations within the spirit of the invention and scope of the claims.

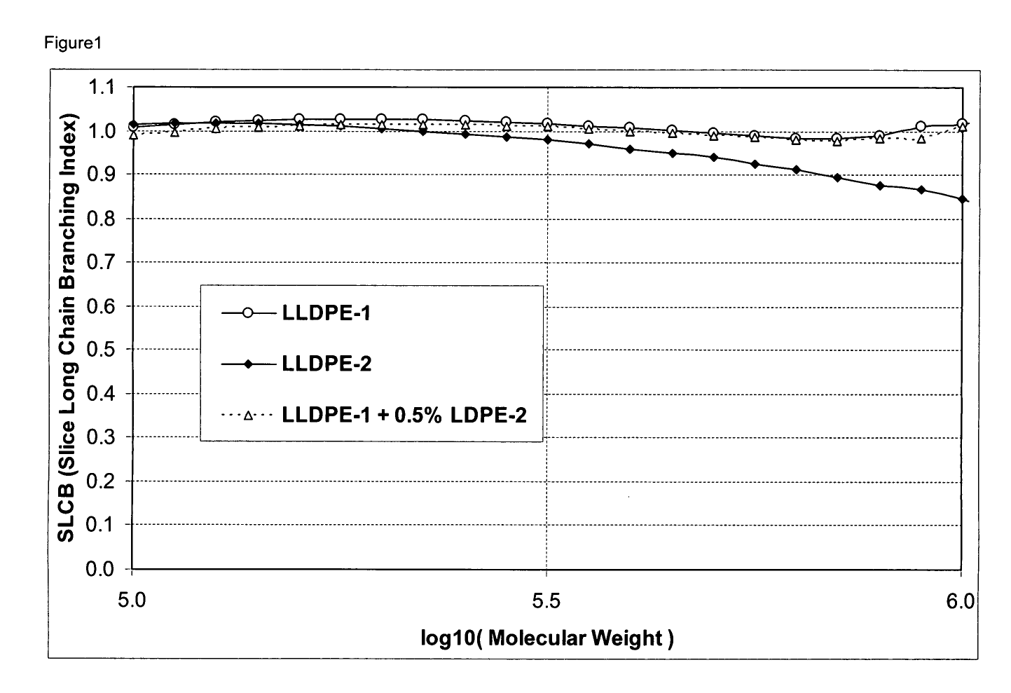

Blends of the examples were prepared using the following LDPE, LLDPE and additive components:
LDPE-1 LDPE having a density of 0.923 g/cm³ and an MI of 5.6 dg/min., commercially available from Equistar Chemicals, LP.
LDPE-2 LDPE having a density of 0.920 g/cm³ and an MI of 0.18 dg/min., commercially available from Equistar Chemicals, LP.
LLDPE-1 LLDPE having a density of 0.918 g/cm³ and an MI of 1.0 dg/min, produced using the catalyst and process described in WO 2005/058982, except that the polymer was produced in a single gas-phase reactor. The SLCB is shown in FIG. 1.
LLDPE-2 LLDPE having a density of 0.918 g/cm³ and an MI of 1.0 dg/min. Equistar Chemicals, LP, containing 0.55 wt % of Polybloc™ antiblock talc, commercially available from Specialty Minerals Inc. The SLCB is shown in FIG. 1.
LLDPE-3 Same as LLDPE-1 except that it contains 1 wt % of a talc masterbatch (50 wt % ABT2500 talc in octene LLDPE, commercially available from Ampacet)
Adt-1 HMO5C talc, commercially available from IMI FABI.

All parts and percentages used in this specification are by weight unless otherwise specified.

In the following examples, all blown films were produced in an LLDPE blown film line equipped with a 2″ diameter smooth-bore extruder, 24:1 L/D barrier screw with a Maddock mixing section. The smooth bore extruder was equipped with a 4″ diameter die and 0.100″ die gap. Operating conditions included an output rate of 63 lb/hr, a blow-up-ratio of 2.5:1, a 12″ frostline height and melt temperature of approximately 215° C.

### Control Example 1

LLDPE-1 was melt extruded in a Banbury mixer to form an extrudate. A blown film of 1 mil thickness was then prepared from the extrudate.

### Comparative Example 2

A blend containing 99.5 wt % LLDPE-1 and 0.5 wt % LDPE-1 was prepared by melt-extruding the components in a Banbury mixer to form an extrudate. A blown film of 1 mil thickness was then prepared from the extrudate.

### Comparative Example 3

A blend and film were prepared as in Comparative Example 2 except that 99.0 wt % LLDPE-1 and 1 wt % LDPE-1 was used.

### Example 4

A blend and film were prepared as in Comparative Example 2 except that 0.5 wt % LDPE-2 instead of LDPE-1 was used.

Physical and optical properties of the films prepared from Control Example 1, Comparative Examples 2 and 3, and Example 4 are summarized in Table 1.

TABLE 1

| | Control | Comparative | Comparative | |
|---|---|---|---|---|
| | Example 1 | Example 2 | Example 3 | Example 4 |
| Haze, % | 24.9 | 12.2 | 9.6 | 10.1 |
| Gloss-45, % | 28.8 | 49.8 | 59.0 | 57.4 |
| Clarity, % | 57.1 | 75.4 | 78.5 | 78.6 |
| DDI, g/mil | 94 | 93 | 86 | 91 |
| MD-Tear, | 113 | 106 | 97 | 99 |
| g/mil | | | | |

The results demonstrate comparable optical and impact property performance are obtained with the blends of the invention using low MI LDPE, at approximately half the levels of blends using higher MI LDPE.

### Control Example 5

A blend containing 99.7 wt % LLDPE-1 and 0.3 wt % Adt-1 was prepared by processing the blend components in a Banbury mixer to form an extrudate. A 1 mil blown film was then prepared from the extrudate.

### Comparative Example 6

A blend containing 99.2 wt % LLDPE-1, 0.3 wt % Adt-1 and 0.5 wt % LDPE-1 was prepared by processing the blend components in a Banbury mixer to form an extrudate. A blown film was then formed from the extrudate.

### Comparative Example 7

A blend and film were prepared as in Comparative Example 6 except that 98.7 wt % LLDPE-1 and 1.0 wt % LDPE-1 was used.

### Example 8

A blend and film were prepared as in Comparative Example 6 except that 0.5 wt % LDPE-2 was used instead of LDPE-1.

### Control Example 9

A film was produced from LLDPE-2.

### Comparative Example 10

A film was prepared from a blend of 99.0 wt % LLDPE-2 and 1 wt % LDPE-2. The LDPE and LLPE were dry-blended by feeding both together into the feed hopper of the blown film extruder.

Physical and optical properties of the films prepared from antiblock-containing samples Control Example 5, Comparative Examples 6, 7, 9, and 10, and Example 8 are summarized in Table 2.

TABLE 2

| | Control | Comp. | Comp. | | Control | Comp. |
|---|---|---|---|---|---|---|
| | Ex. 5 | Ex. 6 | Ex. 7 | Ex. 8 | Ex. 9 | Ex. 10 |
| Haze, % | 29.1 | 16.6 | 13.7 | 14.1 | 17 | 16 |
| Gloss-45, % | 25.2 | 44.8 | 52.3 | 50.5 | — | — |
| Clarity, % | 13.1 | 36.0 | 40.6 | 38.8 | — | — |
| DDI, g/mil | 98 | 97 | 97 | 101 | 88 | 89 |
| MD-Tear, | 123 | 114 | 103 | 104 | 99 | 78 |
| g/mil | | | | | | |

The results demonstrate that comparable optical and impact property performance is obtained with the blends of the invention using low MI LDPE, at approximately half the levels of blends using higher MI LDPE. The data also illustrates that addition of the LDPE material into LLDPE material having an SLCB index below 0.96 shows minimal reduction in haze.

### Control Example 11

LLDPE-3 was processed in a Banbury mixer to form an extrudate. A blown film of 1 mil thickness was then prepared from the extrudate.

### Comparative Example 12

A film was prepared from a blend of 99 wt % LLDPE-3 and 1 wt % LDPE-2. The LDPE and LLPE were dry-blended by feeding both together into the feed hopper of the blown film extruder.

### Example 13

A blend containing 99 wt % LLDPE-1, 0.5 wt % LDPE-2 and 0.5 wt % Adt-1 was prepared by melt-blending the components in a Banbury mixer to form an extrudate. A blown film was then prepared from the extrudate.

Physical and optical properties of the films prepared from Control Example 11, Comparative Example 12 and Example 13 are summarized in Table 3.

TABLE 3

| | | Comparative | |
|---|---|---|---|
| | Control | Example | Example |
| | Example 11 | 12 | 13 |
| Haze, % | 32 | 20 | 14 |
| DDI, g/mil | 89 | 86 | 101 |
| MD-Tear, | 108 | 90 | 104 |
| g/mil | | | |

These results demonstrate that films formed from the extrudate of melt-extruded blends of LDPE and LLDPE demonstrate improved optical and physical properties over blends of LDPE and LLDPE produced through dry-blending of the components.

The present subject matter being thus described, it will be apparent that the same may be modified or varied in many ways. Such modifications and variations are not to be regarded as a departure from the spirit and scope of the present subject matter, and all such modifications and variations are intended to be included within the scope of the following claims.

I claim:

1. A film comprising a polymer blend of:
(a) 0.3 to 0.8 wt % LDPE; and
(b) 99.2 to 99.7 wt % LLDPE,
the LDPE having an MI of 0.1 to 0.6 dg/min, and the LLDPE having a slice long chain branching of at least 0.96 for any portion of the composition having a molecular weight of 100,000 or above, wherein the film is formed from an extrudate of the blend.

2. The film of claim 1 wherein the LDPE is present in an amount from 0.3 to 0.6 wt %.

3. The film of claim 1 wherein the LDPE MI is 0.1 to 0.4 dg/min.

4. The film of claim 1 wherein the LLDPE is produced using a Ziegler Natta catalyst.

5. The film of claim 1 wherein the LLDPE is a copolymer of ethylene and a comonomer selected from 1-butene, 1-hexene or 1-octene.

6. The film of claim 5 wherein the comonomer is 1-butene or 1-hexene.

7. The film of claim 5 wherein the comonomer is present in an amount from 2 to 12 wt %.

8. The film of claim 1 produced by a blown film process.

9. A process comprising forming a film from an extrudate of a polymer blend, the blend comprising:
(a) 0.3 to 0.8 wt % LDPE; and
(b) 99.2 to 99.7 wt % LLDPE,
the LDPE having an MI of 0.1 to 0.6 dg/min, and the LLDPE having a slice long chain branching of at least 0.96 for any portion of the composition having a molecular weight of 100,000 or above.

10. The process of claim 9 wherein the LDPE is present in an amount from 0.3 to 0.6 wt %.

11. The process of claim 9 wherein the LDPE MI is 0.1 to 0.4 dg/min.

12. The process of claim 9 wherein the LLDPE is produced using a Ziegler Natta catalyst.

13. The process of claim 9 wherein the LLDPE is a copolymer of ethylene and a comonomer selected from 1-butene, 1-hexene or 1-octene.

14. The process of claim 13 wherein the comonomer is 1-butene or 1-hexene.

15. The process of claim 14 wherein the comonomer is present in an amount from 2 to 12 wt %.

16. A polymer blend comprising:
(a) 0.3 to 0.8 wt % LDPE; and
(b) 99.2 to 99.7 wt % LLDPE,
the LDPE having an MI of 0.1 to 0.6 dg/min, and the LLDPE having a slice long chain branching of at least 0.96 for any portion of the composition having a molecular weight of 100,000 or above.
